(19) United States
(12) Patent Application Publication
(10) Pub. No.: US 2010/0088102 A1
(43) Pub. Date: Apr. 8, 2010

(54) AUDIO CODING AND REPRODUCING APPARATUS

(75) Inventors: Shingo Urata, Nara (JP); Ichiro Kawashima, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/597,776

(22) PCT Filed: Jan. 24, 2008
(86) PCT No.: PCT/JP2008/051005

§ 371 Date: Oct. 27, 2009

(30) Foreign Application Priority Data
May 21, 2007 (JP) 2007-134228

(51) Int. Cl. G10L 21/00

(52) U.S. Cl. 704/500; 704/E21.001

(57) ABSTRACT

In order to reduce the problem that sound cuts out due to overflow of audio output data caused by a delay in shifting to an audio reproducing process, an audio coding and reproducing apparatus includes: an input data storage unit in which PCM audio signals are stored; an output data storage unit in which data to be outputted is stored; an audio output unit configured to output the audio data; an audio coding unit configured to code the audio data; a coded data storage unit configured to store the audio data coded by the audio coding unit; a bitrate control unit configured to control a bitrate at which the coded data is outputted, based on an amount of free space of the output data storage unit; and a data memory unit configured to retain the coded data.

### TECHNICAL FIELD

The present invention relates to an audio coding and reproducing apparatus in which digital audio data is coded and reproduced at the same time.

### BACKGROUND ART

In recent years, to respond to requests of users for ready access to music, various techniques have been developed to compressively code audio data signals of voice, music sounds, etc. at low bitrate and expansively decode them for reproduction, and among such systems, MPEG-1 Audio Layer III (hereinafter simply referred to as MP3) is typically known.

As a usage example of MP3, audio signals stored in, for instance, CDs, are compressively coded into MP3 data while being reproduced. MP3 data may be stored in devices such as flash memory and Hard Disk.

To reproduce and compressively code audio at the same time, there are two ways; one way is to perform processing in separate devices for audio coding and for audio output or additional audio processing, and the other way is to perform the audio reproducing process and the audio coding process alternately at the same time.

In the case of performing the audio reproducing process and the audio coding process alternately at the same time, the processing can be carried out in a single-chip system LSI, which provides an advantage that the system cost can be reduced.

For example, a coding device has been disclosed for preventing buffer overflows and underflows that occur in conventional encoders and decoders (refer to Patent Reference 1, for example). Patent Reference 1: Japanese Unexamined Patent Application Publication No. 2000-307661

### DISCLOSURE OF INVENTION

### Problems that Invention is to Solve

However, the above-mentioned flash memory storing MP3 data has a function to search blocks by excluding unwritable blocks, and Hard Disk repeats to read and write data, which causes the data to be fragmented and to be thus read and written at lower speed. As a result, the late transfer from the coded data storage unit to the storage unit such as Hard Disk or flash memory causes a delay in shifting to the audio reproducing process. The delayed timing for the audio data output from the output data storage unit leads to a delay in the shifting to the audio reproducing process, which causes overflow of the audio output data and raises such problems that the sound will cut out.

In view of such problems, the present invention has been conceived, aiming to provide an audio coding and reproducing apparatus which reduces the problem that the sound cuts out due to the overflow of the audio output data caused by a delay in the shifting to the audio reproducing process.

### Means to Solve the Problems

In order to solve aforementioned problems, an audio coding and reproducing apparatus according to the present invention is provided, which codes and reproduces audio from audio data of PCM audio signals inputted, the audio coding and reproducing apparatus comprising:

an input data storage unit in which the audio data inputted is stored;

an output data storage unit in which the audio data from the input data storage unit is stored;

an audio output unit configured to output the audio data stored in the output data storage unit;

an audio coding unit configured to code the audio data stored in the input data storage unit;

a coded data storage unit configured to store the audio data coded by the audio coding unit;

a control unit configured to reduce an amount of the coded data to be stored in the coded data storage unit based on an amount of free space of the coded data storage unit; and

a data memory unit configured to retain the coded data transmitted from the coded data storage unit.

Further, the control unit is a bitrate control unit configured to lower a coding bitrate in the audio coding unit when an amount of the coded data stored in the coded data storage unit is equal to or greater than a threshold.

Furthermore, the control unit is a speed adjustment unit configured to reduce an audio reproduction speed in the audio output unit so as to reduce an amount of the coded data to be stored in the coded data storage unit when the amount of the coded data stored in the coded data storage unit is equal to or greater than a threshold.

With these structures, when the amount of the data stored in the coded data storage unit used for temporarily storing the coded data is equal to or greater than the threshold, the control unit operates as the bitrate control unit to lower the audio coding bitrate or as the speed adjustment unit to reduce the audio reproduction speed in the audio output unit to reduce the amount of data to be stored in the coded data storage unit so that delays in transfer to the data memory unit such as Hard Disk can be reduced, and it is therefore possible to appropriately prevent the cut-out of audio output that results form the delays in transfer to the data memory unit.

Further, the control unit is a sampling rate conversion unit configured to convert a sampling rate of the data that is transferred from the input data storage unit to the output data storage unit,

the audio coding and reproducing apparatus further comprises a shared buffer shared by the output data storage unit and the coded data storage unit, and

the sampling rate conversion unit is configured to reduce the sampling rate of the data to be stored in the output data storage unit and to increase an allocation of the shared buffer to the coded data storage unit when the amount of the coded data stored in the coded data storage unit is equal to or greater than a threshold.<0}

Furthermore, the control unit is an output channel conversion unit configured to convert the number of output channels for the data that is transferred from the input data storage unit to the output data storage unit,

the audio coding and reproducing apparatus further comprises a shared buffer shared by the output data storage unit and the coded data storage unit, and

the output channel conversion unit is configured to reduce the number of output channels for the data to be stored in the output data storage unit and to increase an allocation of the shared buffer to the coded data storage unit when the amount of the coded data stored in the coded data storage unit is equal to or greater than a threshold.

With these structures, when the amount of the data stored in the coded data storage unit used for temporarily storing the coded data is equal to or greater than the threshold, the sampling rate is reduced in the sampling rate conversion unit, or the number of output channels is reduced in the output channel conversion unit, and in order to increase a data region of the shared buffer allocated to the coded data storage unit, the amount of data to be stored in the coded data storage unit is reduced, so that delays in transfer to the data memory unit such as Hard Disk can be reduced, and it is therefore possible to appropriately prevent the cut-out of audio output that results form the delays in transfer to the data memory unit.

Moreover, the present invention is capable of not only providing the audio coding and reproducing apparatus as above, but also providing an audio coding and reproducing method in which the characteristic means of the audio coding and reproducing apparatus are used as steps, as well as providing a program or integrated circuit which causes computers to execute these steps. Such a program is, needless to say, distributable via recording media such as CD-ROMs and transmission media such as Internet.

### EFFECTS OF THE INVENTION

In the audio coding and reproducing apparatus according to the present invention, when a content in a buffer for temporarily storing coded data exceeds a threshold, the amount of coded data is decreased by, for example, lowering the audio coding bitrate so that delays in transfer to the data memory unit can be reduced, and it is therefore possible to appropriately prevent the cut-out of audio output that results form the delays in transfer to the data memory unit.

### BRIEF DESCRIPTION OF DRAWINGS

FIG. 1 is a functional block diagram showing an audio coding and reproducing apparatus according to the first embodiment.

FIG. 2 is a flowchart showing a process of operation in the audio coding and reproducing apparatus according to the first embodiment.

FIG. 3 is a functional block diagram showing an audio coding and reproducing apparatus according to the second embodiment.

FIG. 4 is a flowchart showing a process of operation in the audio coding and reproducing apparatus according to the second embodiment.

FIG. 5 is a functional block diagram showing an audio coding and reproducing apparatus according to the third embodiment.

FIG. 6 is a flowchart showing a process of operation in the audio coding and reproducing apparatus according to the third embodiment.

FIG. 7 is a functional block diagram showing an audio coding and reproducing apparatus according to the fourth embodiment.

FIG. 8 is a flowchart showing a process of operation in the audio coding and reproducing apparatus according to the fourth embodiment.

### NUMERICAL REFERENCES

100, 300, 500, 700 Audio coding and reproducing apparatus
101 Input data storage unit
102 Output data storage unit
103 Audio output unit
104 Audio coding unit
105 Coded data storage unit
106 Bitrate control unit
107 Data memory unit
108,301,501,701 LSI
302 Speed adjustment unit
502,702 Shared buffer
503 Sampling rate conversion unit
703 Output channel conversion unit

### BEST MODE FOR CARRYING OUT THE INVENTION

Hereinafter, the embodiments of the audio coding and reproducing apparatus according to the present invention will be explained with reference to the drawings.

### First Embodiment

The first embodiment of the audio coding and reproducing apparatus according to the present invention will be hereinbelow explained with reference to drawings. It is to be noted that the audio coding and reproducing apparatus according to this first embodiment is characterized in that an audio coding bitrate is lowered in a bitrate control unit when an amount of audio data stored in the coded data storage unit exceeds a threshold.

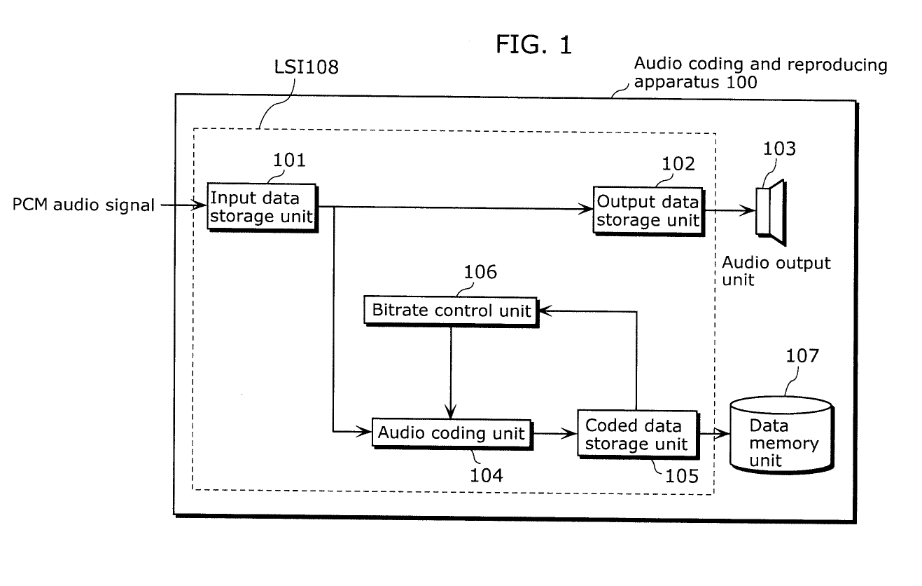

FIG. 1 is a block diagram showing a configuration of an apparatus for reproducing and coding PCM audio signals in the first embodiment of the present invention. FIG. 1 has a purpose of showing that reproduction and coding of the PCM audio signals are performed in a single apparatus. Although there is another way; the input data to be reproduced is stored in a buffer while the input data to be coded is stored in another buffer so that the coding process is performed in another device, this way requires a higher system cost and this is why the single apparatus is now provided to perform the professing.

Further, in an area enclosed by dotted lines in FIG. 1, an implementation is achieved such that the audio coding and reproducing apparatus of this first embodiment is operable by a single-chip system LSI 108.

In FIG. 1, the audio coding and reproducing apparatus 100 is an apparatus in which reproduction of the audio signals and the coding of the audio signals are performed at the same time. An input data storage unit 101 temporarily stores inputted PCM audio signals. The audio data to be outputted is read out from the input data storage unit 101 and is temporarily stored in an output data storage unit 102. It is to be noted that between the input data storage unit 101 and the output data storage unit 102, there may be an additional device such as an output audio volume control processor which is not always necessary and is therefore not shown in FIG. 1.

An audio output unit 103 outputs the audio data stored in the output data storage unit 102. An audio coding unit 104 codes the PCM audio signals stored in the input data storage unit 101 and brings the coded data to a coded data storage unit 105 where the coded data is temporarily stored. A bitrate control unit 106 controls a coding bitrate in the audio coding unit 104 based on free space of the coded data storage unit 105. The coded data is moved from the coded data storage unit 106 to a data memory unit 107 where the coded data is retained.

In the audio coding and reproducing apparatus 100, one buffer is used for both the input data for audio reproduction and the input data for audio coding. Thus, input data to be processed next should be put into the input data storage unit 101 after completion of the audio reproducing process and the audio coding process. If the transfer to the data memory unit 107 delays, the coded data will not be held in the coded data storage unit 105 and therefore, a subsequent audio reproducing process is unable to start, which causes a problem that overflow occurs in the audio output.

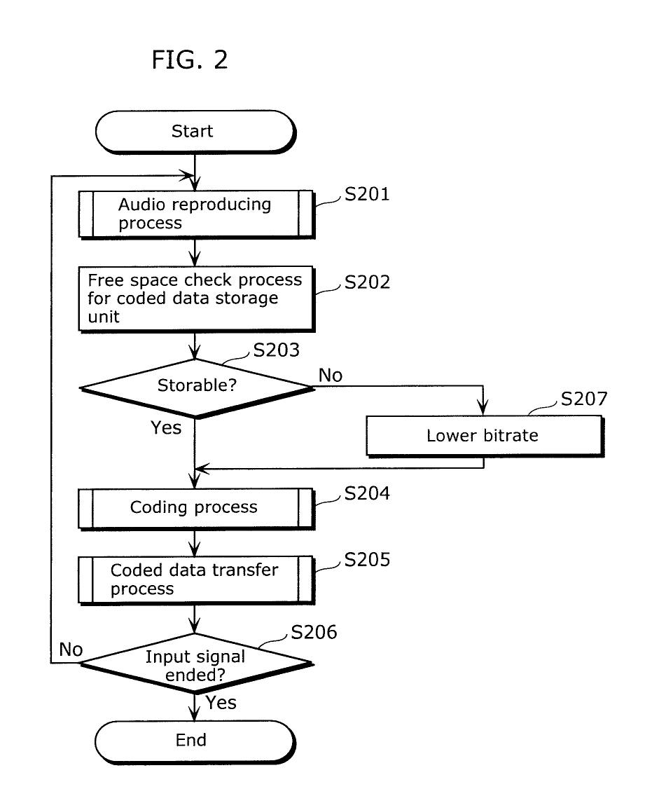

FIG. 2 is a flowchart showing a process of operation in the audio coding and reproducing apparatus according to this first embodiment.

First, the audio coding and reproducing apparatus reads out the PCM audio signals to perform an audio signal reproducing process (S201).

Following the audio reproducing process, it is detected whether or not there is still any free space left in the coded data storage unit 105 (S202). When the free space of the coded data storage unit 105 is equal to or greater than a threshold and it is determined that incoming data is storable (corresponding to “Yes” in S203), the coding process is performed at unchanged bitrate (S204).

In contrast, when the free space of the coded data storage unit 105 is equal to or less than the threshold and it is determined that incoming data is not storable (corresponding to “No” in S203), the bitrate is lowered (S207) and then the coding process is performed at the lowered bitrate (S204). After that, processing is performed to move the coded data from the coded data storage unit 105 to the data memory unit 107 (S205), and the above steps will be repeated until the end of the input signals (corresponding to “Yes” in S206).

As described above, in the audio coding and reproducing apparatus according to this first embodiment, the coding bitrate is lowered to reduce the amount of data to be inputted to the coded data storage unit 105 so that the overflow can be prevented which is attributed to the delays in shifting to a subsequent audio reproducing process due to a lack of free space of the coded data storage unit 105. As a result, the decrease of the coded data by lowering the coding bitrate brings about an effect that the audio output is less frequently cut out than a conventional technique which has the problem that audio output is cut out due to the delays in transfer of audio coded data to a memory unit, for reasons of avoidance of blocks unwritable into the memory unit, reasons of data fragmentation, or the like reasons.

### Second Embodiment

The second embodiment of the audio coding and reproducing apparatus according to the present invention will be hereinbelow explained with reference to drawings. It is to be noted that the audio coding and reproducing apparatus according to this second embodiment is characterized in that a speed of audio data being outputted is reduced in a speed adjustment unit when an amount of audio data stored in the coded data storage unit exceeds a threshold.

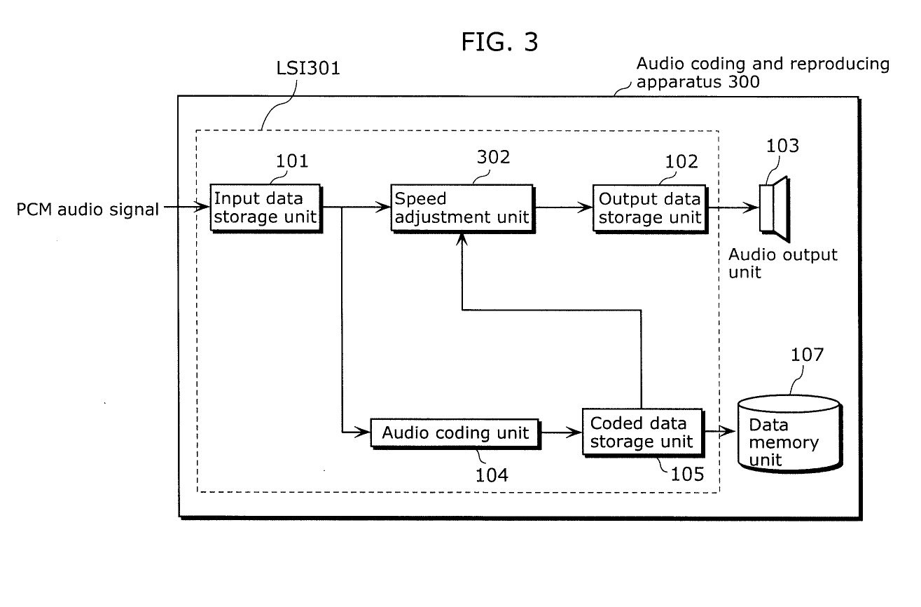

FIG. 3 is a functional block diagram showing an apparatus for reproducing and coding PCM audio signals according to the second embodiment. FIG. 3 has a purpose of showing that reproduction and coding of the PCM audio signals are performed in a single apparatus. Although there is another way; the input data to be reproduced is stored in a buffer while the input data to be coded is stored in another buffer so that the coding process is performed in another device, this way requires a higher system cost and this is why the single apparatus is now provided to perform the processing.

Further, in an area enclosed by dotted lines FIG. 3, an implementation is achieved such that the audio coding and reproducing apparatus of this second embodiment is operable by a single-chip system LSI 301.

In FIG. 3, the audio coding and reproducing apparatus 300 is an apparatus in which reproduction of audio signals and coding of the audio signals are performed at the same time. A speed adjustment unit 302 refers to free space of the coded data storage unit 105 and thereby determines whether or not an audio output speed is to be reduced. If the transfer to the data memory unit 107 delays, the coded data will not be held in the coded data storage unit 105 and therefore, a subsequent audio reproducing process is unable to start, which causes a problem that the overflow occurs in the audio output.

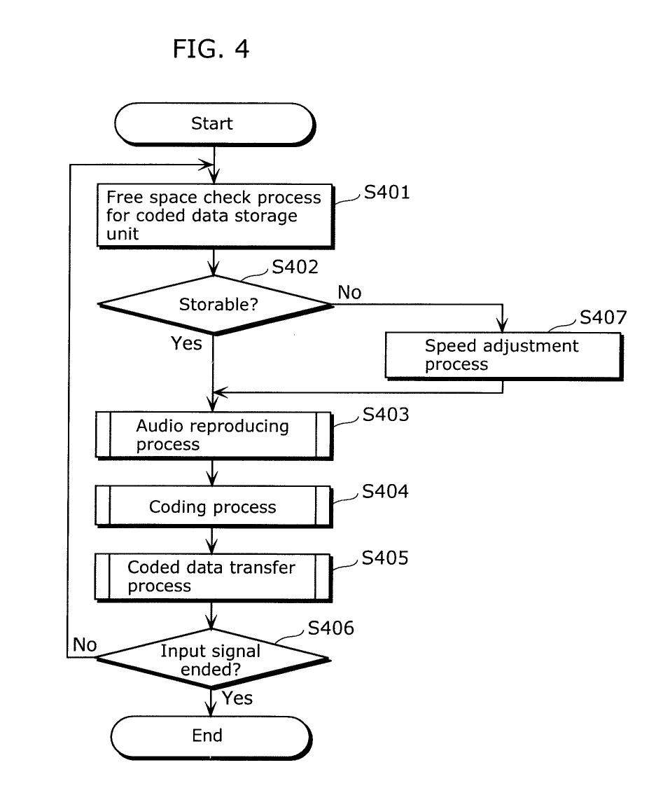

FIG. 4 is a flowchart showing a process of operation in the audio coding and reproducing apparatus according to this second embodiment.

First, in the audio coding and reproducing apparatus, it is detected whether or not there is still any free space left in the coded data storage unit 105 (S401), before the audio reproducing process is performed.

Next, when the free space of the coded data storage unit 105 is equal to or greater than a threshold (corresponding to “Yes” in S402), the audio output unit 103 performs the audio reproducing process at unchanged audio output speed (S403).

After the audio reproducing process is performed (S403), the coding process is performed in the audio coding unit 104 (S404), coded data is stored in the coded data storage unit 105, and the coded data transfer process is then performed to move the coded data to the data memory unit 107 (S405).

In contrast, when the free space of the coded data storage unit 105 is less than the threshold (corresponding to “No” in S402), there is a possibility of a delay in transfer of previously coded data to the data memory unit 107 and therefore, the speed adjustment unit 302 performs processing to reduce the audio reproduction speed (S407), and the steps following S401 will be repeated until the end of the input signals (corresponding to “Yes” in S406).

As described above, in the audio coding and reproducing apparatus according to this second embodiment, the audio reproduction speed is reduced in the speed adjustment unit 302 to secure time for transferring data to the data memory unit 107 when it is determined that the amount of coded data stored in the data storage unit exceeds the threshold. As a result, reducing the audio reproduction speed brings about an effect of preventing the sound cut-out caused by overflow even when the coded data storage unit 105 runs out of free space and a subsequent audio reproducing process delays.

### Third Embodiment

The third embodiment of the audio coding and reproducing apparatus according to the present invention will be hereinbelow explained with reference to drawings. It is to be noted that the audio coding and reproducing apparatus according to this third embodiment is characterized in that when an amount of data stored in the coded data storage unit exceeds a threshold, sampling rate is reduced and together, an allocation of a shared buffer to the coded data storage unit is increased.

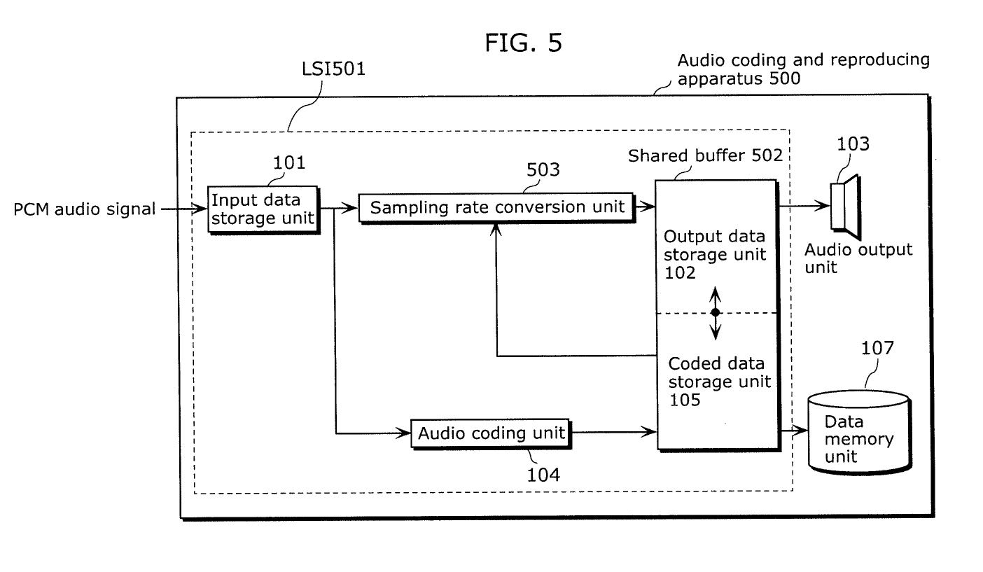

FIG. 5 is a structural block diagram showing an apparatus for reproducing and coding PCM audio signals in the third embodiment of the present invention. FIG. 5 has, as in the embodiments described above, a purpose of showing that reproduction and coding of the PCM audio signals are performed in a single apparatus. Although there is another way; the input data to be reproduced is stored in a buffer while the input data to be coded is stored in another buffer so that the coding process is performed in another device, this way requires a higher system cost and this is why the single apparatus is now provided to perform the processing.

As shown in FIG. 5, the output data storage unit 102 and the coded data storage unit 105 contained in a shared buffer 502 use a common data region and according to processing circumstances, allocated regions can vary as shown by a pointer in the shared buffer 502 in FIG. 5. Further, in an area enclosed by dotted lines FIG. 5, an implementation is achieved such that audio coding and reproducing apparatus of this third embodiment is operable by a single-chip system LSI 501.

In FIG. 5, the audio coding and reproducing apparatus 500 is an apparatus in which reproduction of audio signals and coding of the audio signals are performed at the same time. A sampling rate conversion unit 503 refers to free space of the coded data storage unit 105 and thereby determines whether or not the sampling rate is to be converted. If the transfer to the data memory unit 107 delays, the coded data will not be held in the coded data storage unit 105 and therefore, a subsequent audio reproducing process is unable to start, which causes a problem that the overflow occurs in the audio output.

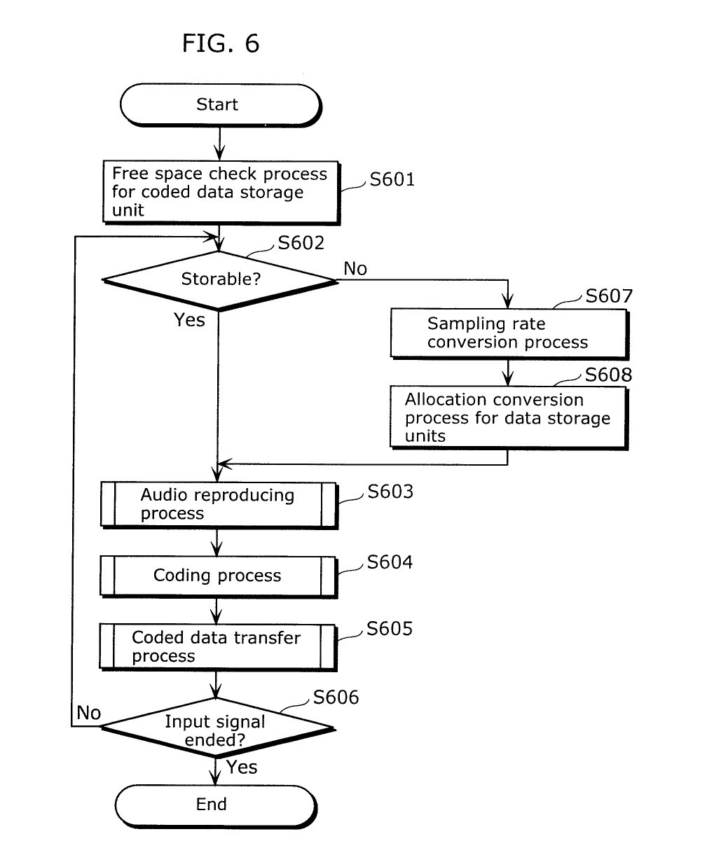

FIG. 6 is a flowchart showing a process of operation in the audio coding and reproducing apparatus according to this third embodiment.

First, it is detected whether or not there is still any free space left in the coded data storage unit 105 (S601), before the audio reproducing process is performed.

Next, an amount of the coded data stored in the coded data storage unit 105 is checked and when the amount is equal to or greater than a threshold (corresponding to “Yes” in S602), the audio reproducing process is performed with sampling rate unchanged.

In contrast, when the free space of the coded data storage unit 105 is equal to or less than the threshold (corresponding to “No” in S602), there is a possibility of a delay in transfer of previously coded data to the data memory unit 107 and therefore, the sampling rate conversion unit 503 performs processing to convert the sampling rate and thereby decrease an amount of output data (S607).

The decrease in the data amount then initiates processing to allocate to the coded data storage unit 105 some region allocated to the output data storage unit 102 (S608) so that when the coded data storage unit 105 is running out of free space, no waiting time will be required to ensure that the output from the audio output unit 103 will not cut out.

After the audio reproducing process is performed (S603), the coding process is performed in the audio coding unit 104 (S604), coded data is stored in the coded data storage unit 105, and the coded data transfer process is then performed to move the coded data to the data memory unit 107 such as Hard Disk or flash memory (S605).

As described above, in the audio coding and reproducing apparatus according to this third embodiment, the sampling rate is converted to decrease the amount of output data as well as to increase a region of the shared buffer allocated to the coded data storage unit 105, which brings about an effect of preventing the sound cut-out caused by overflow even when the coded data storage unit 105 runs out of free space and a subsequent audio reproducing process delays.

### Fourth Embodiment

The fourth embodiment of the audio coding and reproducing apparatus according to the present invention will be hereinbelow explained with reference to drawings. It is to be noted that the audio coding and reproducing apparatus according to this fourth embodiment is characterized in that output changes by an output channel conversion unit and together, a region of the shared buffer allocated to the coded data storage unit 105 expands.

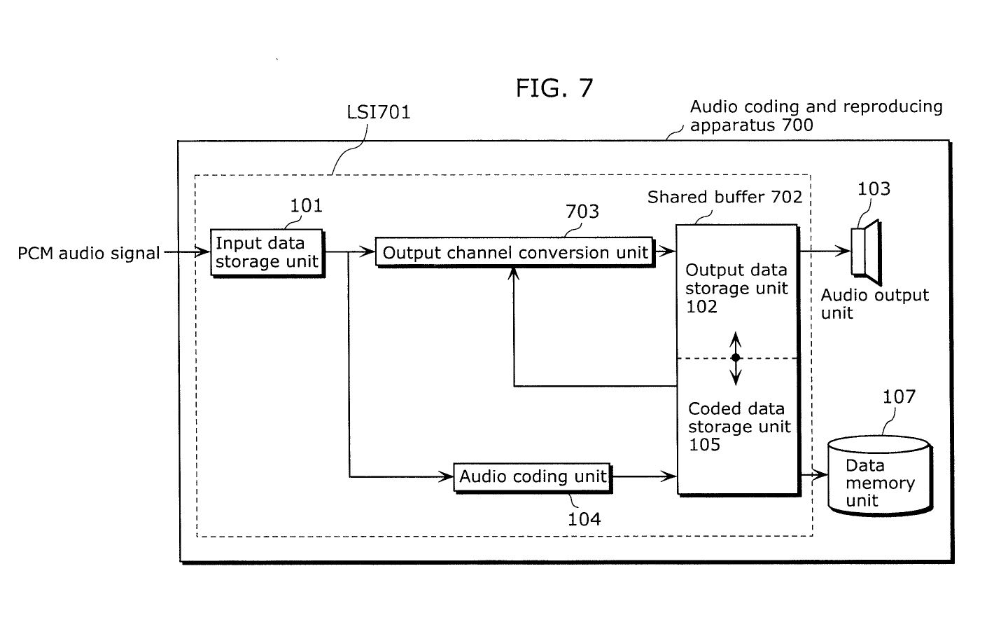

FIG. 7 is a block diagram showing a configuration of an apparatus for reproducing and coding PCM audio signals in the this fourth embodiment.

FIG. 7 has a purpose of showing that reproduction and coding of the PCM audio signals are performed in a single apparatus. Although there is another way; the input data to be reproduced is stored in a buffer while the input data to be coded is stored in another buffer so that the coding process is performed in another device, this way requires a higher system cost and this is why the single apparatus is now provided to perform the processing. It is to be noted that the output data storage unit 102 and the coded data storage unit 105 use a common data region to form a shared buffer 702 and according to processing circumstances, their allocation can vary as shown by a pointer in the shared buffer 702 in FIG. 7.

Further, in an area enclosed by dotted lines FIG. 7, an implementation is achieved such that the audio coding and reproducing apparatus of this fourth embodiment is operable by a single-chip system LSI 701.

In FIG. 7, the audio coding and reproducing apparatus 700 is an apparatus in which reproduction of audio signals and coding of the audio signals are performed at the same time. An output channel conversion unit 703 refers to free space of the coded data storage unit 105 and thereby determines whether or not the number of output channels is to be converted. If the transfer to the data memory unit 107 delays, the coded data will not be held in the coded data storage unit 105 and therefore, a subsequent audio reproducing process is unable to start, which causes a problem that the overflow occurs in the audio output.

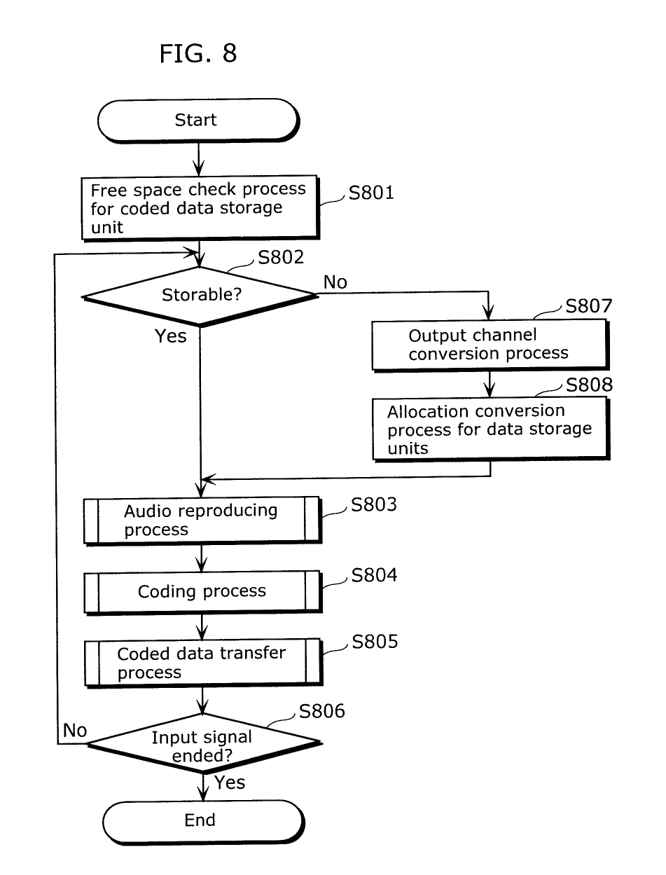

FIG. 8 is a flowchart showing a process of operation in the audio coding and reproducing apparatus according to this fourth embodiment.

First, it is detected whether or not there is still any free space left in the coded data storage unit 105 (S801), before the audio reproducing process is performed.

Next, when the free space of the coded data storage unit 105 is equal to or greater than a threshold (corresponding to “Yes” in S802), the audio reproducing process is performed without converting the number of output channels.

When the free space of the coded data storage unit 105 is equal to or less than the threshold (corresponding to “No” in S802), there is a possibility of a delay in transfer of previously coded data to the data memory unit 107 and therefore, the output channel conversion unit 703 performs processing to convert the number of output channels and thereby decrease an amount of output data (S807).

The decrease in the data amount causes some region allocated to the output data storage unit 102, to be reallocated to the coded data storage unit 105 so that when the coded data storage unit 105 is running out of free space, no waiting time will be required to ensure that the output from the audio output unit will not cut out.

After the audio reproducing process is performed (S803), the coding process is performed in the audio coding unit 104 (S804), coded data is stored in the coded data storage unit 105, and the coded data transfer process is then performed to move the coded data to the data memory unit 107 such as Hard Disk or flash memory (S805).

As described above, in the audio coding and reproducing apparatus according to this fourth embodiment, the output channels are converted to decrease the amount of output data to be allocated to the output data storage unit as well as to increase the region of the shared buffer allocated to the coded data storage unit 105, which brings about an effect of preventing the sound cut-out caused by overflow even when the coded data storage unit 105 runs out of free space and a subsequent audio reproducing process delays.

### INDUSTRIAL APPLICABILITY

The audio coding and reproducing apparatuses according to the present invention are applicable to e.g. a car navigation system, a DVD player, and the like apparatus in which reproduction and recording of a CD or the like are performed at the same time.

1. An audio coding and reproducing apparatus which codes and reproduces audio from audio data of PCM audio signals inputted, said audio coding and reproducing apparatus comprising:
an input data storage unit in which the audio data inputted is stored;
an output data storage unit in which the audio data from said input data storage unit is stored;
an audio output unit configured to output the audio data stored in said output data storage unit;
an audio coding unit configured to code the audio data stored in said input data storage unit;
a coded data storage unit configured to store the audio data coded by said audio coding unit;
a control unit configured to reduce an amount of the coded data to be stored in said coded data storage unit based on an amount of free space of said coded data storage unit; and
a data memory unit configured to retain the coded data transmitted from said coded data storage unit.

2. The audio coding and reproducing apparatus according to claim 1,
wherein said control unit is a bitrate control unit configured to lower a coding bitrate in said audio coding unit when an amount of the coded data stored in said coded data storage unit is equal to or greater than a threshold.

3. The audio coding and reproducing apparatus according to claim 1,
wherein said control unit is a speed adjustment unit configured to reduce an audio reproduction speed in said audio output unit so as to reduce an amount per unit time of the coded data to be stored in said coded data storage unit when the amount of the coded data stored in said coded data storage unit is equal to or greater than a threshold.

4. The audio coding and reproducing apparatus according to claim 1,
wherein said control unit is a sampling rate conversion unit configured to convert a sampling rate of the data that is transferred from said input data storage unit to said output data storage unit,
said audio coding and reproducing apparatus further comprises a shared buffer shared by said output data storage unit and said coded data storage unit, and
said sampling rate conversion unit is configured to reduce the sampling rate of the data to be stored in said output data storage unit and to increase an allocation of said shared buffer to said coded data storage unit when the amount of the coded data stored in said coded data storage unit is equal to or greater than a threshold.

5. The audio coding and reproducing apparatus according to claim 1,
wherein said control unit is an output channel conversion unit configured to convert the number of output channels for the data that is transferred from said input data storage unit to said output data storage unit,
said audio coding and reproducing apparatus further comprises a shared buffer shared by said output data storage unit and said coded data storage unit, and
said output channel conversion unit is configured to reduce the number of output channels for the data to be stored in said output data storage unit and to increase an allocation of said shared buffer to said coded data storage unit when the amount of the coded data stored in said coded data storage unit is equal to or greater than a threshold.

6. An audio coding and reproducing method for coding and reproducing audio from PCM audio signals inputted, said audio coding and reproducing method comprising:
storing the audio data inputted;
storing the audio data stored in said step of storing the audio data inputted;
outputting the audio data stored in said step of storing the audio data stored;
coding the audio data stored in said step of storing the audio data inputted;
storing the audio data coded in said step of coding the audio data;
reducing an amount of the coded data to be stored in said step of storing the audio data coded, based on an amount of free space in said step of storing the audio data coded; and
retaining the coded data transmitted after said step of storing the audio data coded.

7. A program for use with an audio coding and reproducing apparatus which codes and reproduces audio from PCM audio signals inputted, said program causing a computer to execute:
storing the audio data inputted;
storing the audio data stored in said step of storing the audio data inputted;
outputting the audio data stored in said step of storing the audio data stored;
coding the audio data stored in said step of storing the audio data inputted;
storing the audio data coded in said step of coding the audio data;
reducing an amount of the coded data to be stored in said step of storing the audio data coded, based on an amount of free space in said step of storing the audio data coded; and
retaining the coded data transmitted after said step of storing the audio data coded.

8. An integrated circuit comprising:
an input data storage circuit in which audio data inputted is stored;
an output data storage circuit in which the audio data from said input data storage circuit is stored;
an audio coding circuit configured to code the audio data stored in said input data storage circuit;
a coded data storage circuit configured to store the audio data coded by said audio coding circuit; and
a control circuit configured to reduce an amount of the coded data to be stored in said coded data storage circuit based on an amount of free space of said coded data storage circuit.
